(19) United States
(12) Patent Application Publication
(10) Pub. No.: US 2025/0137950 A1
(43) Pub. Date: May 1, 2025

(54) IN-SITU OZONE GENERATION IN XPS INSTRUMENTS

(71) Applicant: VG Systems Limited, Altrincham (GB)

(72) Inventors: Paul Mack, Bognor Regis (GB); Timothy Sion Nunney, Reigate (GB); Dhilan Sukunan Devadasan, Crawley (GB)

(73) Assignee: VG Systems Limited, Altrincham (GB)

(21) Appl. No.: 18/930,019

(22) Filed: Oct. 29, 2024

(30) Foreign Application Priority Data
Oct. 30, 2023 (GB) 2316578.0

(51) Int. Cl. G01N 23/2273; G01N 31/00

(52) U.S. Cl. CPC G01N 23/2273; G01N 31/00

(57) ABSTRACT

In accordance with the claimed invention, there is provided an apparatus for changing an oxidation state of a surface to be analysed of a sample, the apparatus comprising: a vacuum chamber; a sample holder inside the vacuum chamber, configured to hold a sample having a surface to be analysed; an inlet inside the vacuum chamber, configured to provide a localised supply, to the surface to be analysed, of an agent for changing an oxidation state of the surface to be analysed; and an energy source, configured to provide energy to the agent to facilitate changing the oxidation state of the surface to be analysed. There is also provided a process for changing an oxidation state of a surface to be analysed of a sample and a process for performing X-ray photoelectron spectroscopy, XPS, of a surface to be analysed of a sample.

### CROSS REFERENCE TO RELATED APPLICATION

This application claims priority from application GB 2316578.0, filed Oct. 30, 2023. The entire disclosure of application GB 2316578.0 is incorporated herein by reference.

### FIELD

The present disclosure relates to an apparatus for changing an oxidation state of a surface to be analysed of a sample and to related methods. The apparatus and methods can be used in processes for performing X-ray photoelectron spectroscopy.

### BACKGROUND

Analytical techniques provide ways of inspecting the composition, structure, or other properties of samples. Chemical analysis can involve both qualitative and/or quantitative assessments of the components that are present. Many analytical techniques characterise samples using the way in which samples interact with electromagnetic radiation and/or electromagnetic fields, so the electronic configuration of a sample can impact analysis results. For example, when electromagnetic radiation, such as visible light, ultraviolet, infrared, X-rays, or radio waves, interacts with a sample, it can be absorbed, emitted, or scattered in specific patterns, with the resultant spectra providing information about the sample's composition, structure, and physical properties.

An example of a widely-used analytical technique is X-ray photoelectron spectroscopy (XPS), which can be used to determine the surface chemical composition of materials. XPS is a type of photoemission spectroscopy in which electron population spectra are obtained by irradiating a sample with X-rays. Information about a sample can be inferred from measurement of the kinetic energy and the number of the ejected electrons. XPS can distinguish between different elements present in the surface composition, but it can often also distinguish between different chemical states of the elements. However, one problem in the analysis of XPS data is that, due to limitations on the energy resolution of the XPS analysis system, it can be challenging to distinguish between chemical states with overlapping peaks in the XPS spectrum. Essentially, current peak fitting models used in XPS do not always work well.

WO-2023/031626A1 describes a method for distinguishing between chemical states that involves improved peak fitting by using an agent to gradually change the oxidation state of a sample surface and recording XPS spectra of each oxidation state. Then, through peak fitting these multiple oxidation state datasets, the resultant peak fitting models and, consequently the XPS analysis, can be made more robust. In WO-2023/031626A1, the agents used for changing the oxidation state of the sample surface are typically ozone (for oxidation of the surface) or hydrogen (for reduction of the surface), which can be assisted by irradiation with UV light. The ozone itself is generated preferably by exposure of air (which contains oxygen) to UV light. The apparatus in WO-2023/031626A1 locates the sample in a chamber that is separate from the ultra-high vacuum (UHV) XPS analysis chamber and exposes the sample at a high (typically atmospheric) pressure of the ozone or hydrogen. The sample is then moved to the UHV conditions of the XPS analysis chamber, via a vacuum interlock, in order to record the XPS spectra, as shown in FIGS. 16 and 17 of WO-2023/031626A1, for instance.

Therefore, it is possible using existing techniques to modify the oxidation state of a sample to improve XPS analysis. Moreover, control over the oxidation state of a sample can also be advantageous in other analytical techniques that investigate the electronic configuration of samples. Nevertheless, there remains a need for further improvements to the apparatuses and methods used for analysing samples.

### SUMMARY

Against this background and in accordance with a first aspect, an apparatus according to claim 1 is provided. In accordance with a second aspect, a process according to claim 21 is provided.

The present disclosure provides an apparatus for changing an oxidation state of a surface to be analysed of a sample. The apparatus comprises: a vacuum chamber; a sample holder inside the vacuum chamber, configured to hold a sample having a surface to be analysed; an inlet inside the vacuum chamber, configured to provide a localised supply, to the surface to be analysed, of an agent for changing an oxidation state of the surface to be analysed; and an energy source, configured to provide energy to the agent to facilitate changing the oxidation state of the surface to be analysed.

Thus, changing the oxidation state of the surface of the sample may be carried out in-situ in a vacuum chamber. Therefore, after the oxidation state of the surface of the sample has been changed, there is no need to remove the sample from the vacuum chamber and subsequent contamination of the sample (which may be more likely to occur outside the vacuum chamber) can be reduced or avoided. In contrast, in WO-2023/031626A1, changing of the oxidation state of the sample surface is not performed in-situ in an XPS analysis chamber. Therefore, the oxidation state of the surface of the sample may change further between an initial step of changing the oxidation state of the surface and any subsequent analysis. In the present disclosure, the sample itself is not part of the apparatus.

Removing the need for samples to be transferred in and out of a vacuum chamber continuously can make analysis workflows easier to automate. For instance, the apparatus of the present disclosure can be equipped with one or more detectors (e.g., photoelectron energy analyser) inside the vacuum chamber, which can allow analysis of samples with different oxidation states to be performed entirely in the vacuum chamber. In some embodiments, the apparatus can be used to perform an analysis of a surface of a sample in a first oxidation state, and then to change the oxidation state of the surface of the sample to a second oxidation state, which can then be analysed further without needing to remove the sample from the vacuum chamber. Therefore, the apparatus of the present disclosure can facilitate cleaner analysis of samples, since samples would not be exposed to ambient atmosphere when undergoing a change in oxidation state, and samples can instead be kept under a vacuum or UHV the whole time.

Moreover, using the approach of the present disclosure, UHV conditions can be maintained in the vacuum chamber while an agent (or agents) for changing an oxidation state of the sample surface is introduced. Thus, if the vacuum chamber is used for XPS (i.e. if the vacuum chamber is an XPS analysis chamber), then it is possible to prevent the UHV of the XPS chamber from being significantly disturbed. For instance, by providing a localised source of an agent for changing the oxidation state (e.g., by providing a localised leaking of air or oxygen) and the use of an energy source (e.g., a UV light source, which already exists on many XPS systems) to irradiate the sample surface, it is possible to locally generate ozone from the leaked agent so that a relatively small amount of agent (and hence a low partial pressure of the agent) can be provided while still providing a substantial change in oxidation state.

Localised provision of an agent close to the sample surface can significantly reduce the overall gas loading on the UHV chamber, so that the pressure in the UHV chamber can be prevented from rising beyond a point at which the UHV conditions would become unrecoverable. Prior art systems were designed with the expectation that UHV conditions inside an XPS chamber would not have been able to recover from the high pressures of oxidising agent that would typically be required to change the oxidation state of the surface. Localised leaking of an agent for changing the oxidation state can address such problems with prior art systems.

Hence, embodiments of the present disclosure provide an apparatus in which the oxidation state of the surface of a sample can be changed under vacuum conditions, which can be highly advantageous. The above-noted advantages and other advantages will become apparent from the following detailed description.

The foregoing and other objects, features, and advantages of the invention will become more apparent from the following detailed description, which proceeds with reference to the accompanying figures.

### BRIEF DESCRIPTION OF THE DRAWINGS

Embodiments of the present disclosure will now be described, by way of example only, with reference to the accompanying drawings, in which:

FIG. 1 shows an apparatus of a first embodiment;

FIG. 2 shows an apparatus of a second embodiment;

FIG. 3 shows a reaction for providing an agent for changing the oxidation state of a surface of a sample;

FIG. 4 shows experimental data obtained with an embodiment of the disclosure; and

FIG. 5 shows a method of a third embodiment.

### DETAILED DESCRIPTION

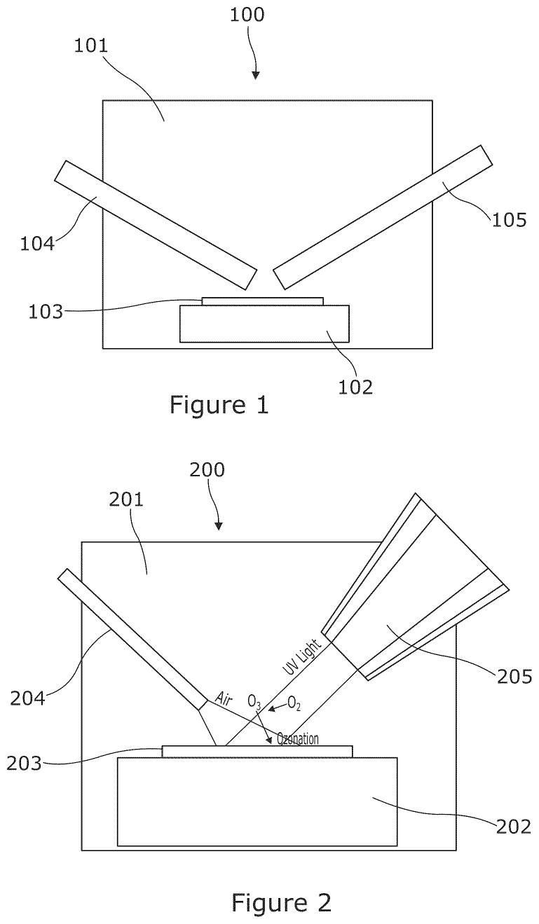

FIG. 1 shows a first embodiment of the present disclosure. The first embodiment is an apparatus 100 for changing an oxidation state of a surface to be analysed of a sample 103. The apparatus 100 comprises: a vacuum chamber 101; a sample holder 102 inside the vacuum chamber 101, configured to hold a sample 103 having a surface to be analysed; an inlet 104 inside the vacuum chamber 101, configured to provide a localised supply, to the surface to be analysed, of an agent for changing an oxidation state of the surface to be analysed; and an energy source 105, configured to provide energy to the agent to facilitate changing the oxidation state of the surface to be analysed.

The inlet 104 and the energy source 105 extend into the vacuum chamber 101. The inlet 104 provides a localised supply of the agent to a region in close proximity to the surface to be analysed of the sample 103 (referred to herein as the surface, for brevity). The energy source 105 is positioned and oriented such that energy is provided to the agent in the region in close proximity to the surface. That is, the energy source 105 emits a form of energy towards the surface. This energy can be used to encourage the agent to cause the oxidation state of the surface to change. For example, the energy source 105 can provide energy (e.g. electrical energy or electromagnetic radiation) that encourages the agent to undergo a reaction to change the oxidation state (i.e., oxidise or reduce) of the surface. Accordingly, the energy source 105 could be, for example, an electrode or a source of electromagnetic radiation to excite the agent. Preferably, the energy is provided simultaneously with supplying the agent, to ensure that the change in oxidation state occurs as quickly as possible.

Since the sample holder 102, the sample 103, the inlet 104 and the energy source 105 are all within the vacuum chamber 101, a high vacuum or UHV can be maintained in the vacuum chamber 101 while the oxidation state of the surface is changed. This may ensure that a desired amount of the agent can be provided to the surface and hence a desired change in oxidation state can be attained. If the sample 103 were to leave the vacuum chamber 101 after undergoing a change in oxidation state, then the surface could be further oxidised (e.g., due to oxidising after being exposed to oxygen in ambient air). Accordingly, the apparatus 100 can be advantageous when used for preparing samples for analysis, where maintaining a vacuum can be helpful.

It should be noted that the apparatus 100 of FIG. 1 does not include a vacuum pump. The apparatus 100 may be provided as a standalone component. Therefore, the apparatus 100 can be connected to a vacuum pump or the apparatus may be connectable to a vacuum pump. The apparatus 100 is preferably configured to change the oxidation state of the surface to be analysed while maintaining a vacuum in the vacuum chamber 101.

The agent in FIG. 1 may be gaseous. However, other forms of agent could be provided. For example, a particulate agent could be provided to the surface to be analysed. Nevertheless, in preferred embodiments, the agent may comprise any one or more of: oxygen (an oxidising agent); ozone (an oxidising agent); and/or hydrogen (a reducing agent). Other oxidising agents or reducing agents could be provided.

FIG. 2 shows a second embodiment of the present disclosure, which operates in a similar way to the first embodiment. FIG. 2 shows a first embodiment of the present disclosure. The first embodiment is also an apparatus 200 for changing an oxidation state of a surface to be analysed of a sample 203. The apparatus 200 comprises a vacuum chamber 201 and a sample holder 202 inside the vacuum chamber 201, configured to hold a sample 203 having a surface to be analysed.

In this embodiment, the walls of the vacuum chamber 201 define an XPS chamber wall, with a UHV inside the XPS chamber and ambient air on the outside. Accordingly, the generalised vacuum chambers described herein may in some embodiments be XPS analysis chambers. Such chambers may comprise an X-ray source and/or a photoelectron energy analyser within the chamber. Embodiments of the present disclosure are particularly advantageous when used in XPS, although other photoemission spectroscopy techniques and analytical techniques (e.g. electron microscopy) can also be performed.

The apparatus 200 of FIG. 2 differs from the apparatus 100 of FIG. 1 in that a specific type of inlet and a specific energy source are shown.

In FIG. 2, the inlet 204 inside the vacuum chamber 201 is configured to provide a localised supply, to the surface to be analysed, of air, which is suitable for changing an oxidation state of the surface to be analysed. That is, the agent of FIG. 1 is air in this embodiment (although in some embodiments, the agent may comprise any one or more of: oxygen; ozone; and/or hydrogen).

The agent can be provided by any suitable inlet for providing gas to the region in close proximity to the sample. For example, a leak valve may be used. The inlet can be elongate (i.e., longer than it is wide) and can extend towards the surface of the sample.

Moreover, FIG. 2 again includes an energy source 205, configured to provide energy to the agent to facilitate changing the oxidation state of the surface to be analysed. In this embodiment, the energy source 205 is a source of ultraviolet (UV) radiation. Therefore, the energy provided to the agent is in the form of electromagnetic radiation. Nevertheless, other energy sources, such as electrodes for providing electrical discharge, can be used.

As shown in FIG. 2, the air and the UV radiation are directed to the surface of the sample 203. The air contains oxygen that converts into ozone when irradiated by the UV radiation. The resulting oxygen can react with the surface of the sample 203 and thereby change the oxidation state of the surface.

The embodiment of FIG. 2 can be used in novel workflows that use ozone to react with sample surfaces within X-ray photoelectron spectroscopy (XPS) instruments, for the purpose of making the analysis of XPS data more straightforward and reliable. A problem in XPS is the prevalence of incorrect/inaccurate XPS data analysis in the literature, which is particularly troublesome for the XPS spectra of some materials that have undefined and lesser-known binding energy values/peak ratios. WO-2023/031626A1 addresses this problem by generating more data out of a single sample through the gradual oxidation of the surface. Thus, when peak fitting these multiple oxidation state datasets, the peak fitting models and, consequently the analysis, becomes more robust. Broadly, WO-2023/031626A1 describes the use of ozone to react with sample surface to achieve this. An issue is that XPS works in UHV, which typically requires moving the sample to an area that can allow localised oxygen to generate ozone, and thus makes the workflow entirely ex-situ relative to the vacuum chamber in which analysis occurs. Thus, the embodiment of FIG. 2 can help to provide an automated workflow that can allow a user to ozonate a sample repeatedly and conduct improved XPS analysis.

A further advantage of the embodiment of FIG. 2 is that some XPS instruments already include an extreme ultraviolet (EUV) or UV light source present. Therefore, the embodiment can be manufactured efficiently, for example by modifying an existing XPS instrument to provide a localised source of an agent, which can interact with EUV or UV to generate ozone on the surface of the sample.

The embodiment of FIG. 2 is particularly adapted to XPS. Therefore, in generalised terms, any of the vacuum chambers described herein may be an X-ray photoelectron spectroscopy, XPS, analysis chamber. Such a chamber may comprise an X-ray source for providing X-rays and/or a photoelectron energy analyser for detecting electrons emitted from the sample. The apparatus described herein may be configured to change the oxidation state of the surface to be analysed a plurality of times (i.e., two or more times) while the sample is inside the vacuum chamber. An X-ray photoelectron spectroscopy, XPS, spectrum may be obtained for each of a plurality of oxidation states of the surface to be analysed. In this way, improved XPS analysis can be performed.

Many features of the embodiments of FIGS. 1 and 2 are generally applicable in the present disclosure. For example, FIGS. 1 and 2 show that in some embodiments of the present disclosure, the energy sources described herein may comprise a radiation source (or radiation sources). A radiation source can interact with the agent to facilitate changing the oxidation state of the surface. In some embodiments, the radiation source may be an electromagnetic radiation source and a wavelength of the electromagnetic radiation source may be from 100 nm to 240 nm. The radiation may be ultraviolet, UV, or extreme ultraviolet, EUV, radiation. Such wavelengths are particularly useful when oxygen is used as the agent as they can facilitate the creation of ozone. However, other wavelengths and agents may be used.

In some embodiments, a wavelength of an electromagnetic radiation source may be tuneable. This may permit tuning of the energy provided to the agent and hence provide control over the degree of change in oxidation state. Various electromagnetic radiation sources can be used. For example, the electromagnetic radiation sources described herein may comprise any one or more of: a mercury vapour lamp; an ultraviolet bulb; a light emitting diode; a gas discharge lamp (which could be filled with various gases, such as He, Ar, Ne, Kr, and also any mixture thereof); plasma-based ultraviolet source; and/or a microwave plasma ultraviolet source.

In some embodiments, electrical energy (e.g., electrical discharge) rather than electromagnetic energy can be used. For example, the energy source may comprise an electrode configured to provide an electrical discharge to the agent. A power supply for providing an appropriate voltage may be provided. For example, a corona discharge may occur at various voltages. In some embodiments, an applied voltage for providing energy may be between 600V and 20 kV. The amount of ozone generated using an electrical discharge may depend on parameters, such as oxygen concentration. In some cases, the voltages provided by the energy source may be at least 1 kV or at least several kV (e.g., >4 kV). In some embodiments, several mg of ozone may be produced per hour with a voltage of approximately ˜2V.

Regardless of the type of energy source used, the energy source may be configured to activate the agent. For instance, the energy source may be used to break chemical bonds or facilitate the breaking of chemical bonds (e.g., to excite the agent without fully breaking chemical bonds) to help change the oxidation state of the surface of the sample (e.g., by converting the agent into an oxidising/reducing agent, or by making the agent more strongly oxidising/reducing).

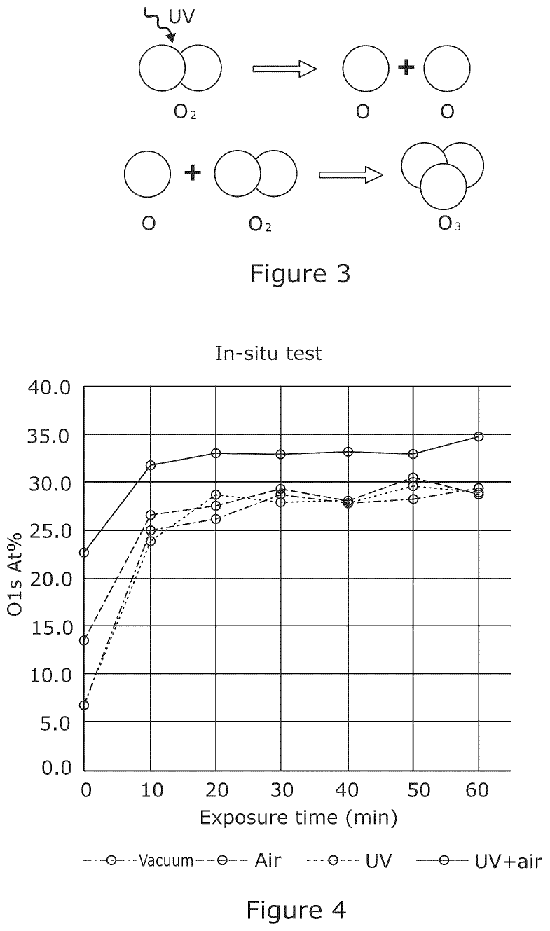

The energy source may be inside the vacuum chamber. The energy source may be fully within the chamber, or may extend into the chamber (e.g., with sealing around the point at which the energy source passes into the vacuum chamber). In either case, a vacuum can be maintained in the vacuum chamber. However, in some embodiments, the energy source may be outside the vacuum chamber. For example, where sources of electromagnetic radiation (e.g., UV bulbs/LEDs or other types) are used as the energy source, these could be provided outside the vacuum chamber, with a transparent window allowing the radiation energy to enter the vacuum chamber and interact with the agent to facilitate changing the oxidation state of the surface to be analysed. FIG. 3 shows the overall process by which ozone can be generated when a UV radiation source is used. Free oxygen atoms from UV excitation of oxygen molecules (O₂) are generated, which then react with other oxygen molecules to form ozone (O₃). The ozone can then react with the sample surface and act as an agent for changing the oxidation state of the surface (i.e., an oxidising agent). The balanced equation for this process is:

$$3 {O}_{2} {\to }^{UV} 2 {O}_{3}$$

FIG. 4 shows a graph from tests showing that oxidation of a sample surface occurs when air is leaked into a vacuum chamber and a UV light source attached to the instrument is turned on. The vertical axis in FIG. 4 represents the atomic percentage of an oxygen peak (for photoelectrons associated with the 1s oxygen orbital). The other scenarios that are shown are: a vacuum is provided in the vacuum chamber; air but no UV is provided in the vacuum chamber; and UV but no air is provided in the vacuum chamber. This shows that the ozone workflows described herein can substantially change the oxidation state of the surface in-situ.

The graph of FIG. 4 was obtained by leaking air into a UHV XPS chamber through a leak valve available in an unmodified vacuum chamber of an existing XPS system. That is, the air was not provided as a localised leak through a dedicated leak valve connected to a needle (or other elongate conduit) terminating close to the sample surface. With an elongate conduit (e.g., needle or other pipe) that terminates close to the sample (e.g., 10 mm to 100 mm from the sample, or from the sample holder if the sample is of negligible thickness), a higher concentration of air would be present at the sample surface and the degree of oxidation would be expected to be higher.

Accordingly, in preferred embodiments of the disclosure, the inlet (that provides a localised supply of an agent for changing an oxidation state of the surface) may comprise a leak valve. Various types of leak valves may be used. For example, the leak valve could be a variable leak valve. A leak valve may include a movable piston with an optically flat surface (e.g. sapphire) that meets a captured metal gasket, although other constructions of leak valve can be used. Leak valves can provide precise control over the amount of agent leaked and can therefore provide control over the pressure in the vacuum chamber.

In some embodiments, the inlet may comprise an elongate conduit (e.g., a needle, or another roughly cylindrical conduit, such as a pipe) extending towards the surface to be analysed. The inlet may terminate in close proximity to the surface to be analysed, ensuring that a relatively small amount of agent is needed to change the oxidation state of the surface. This can avoid significant pressure changes in the vacuum chamber. An advantage of an elongate conduit or needle is that an elongate structure occupies a relatively small space, which prevents the conduit blocking emitted photoelectrons.

In some embodiments, the inlet may terminate at (i.e., the end point of the inlet may be positioned at) a distance (i.e., the shortest distance) of up to 200 mm or up to 100 mm from the surface to be analysed. Additionally or alternatively the inlet may terminate at a distance (i.e., the shortest distance) of at least 5 mm, at least 10 mm, or at least 50 mm from the surface to be analysed. A preferred range of distances for the distance from the termination point of the inlet to the sample surface is 10 mm to 100 mm. However, this distance is specific to each system, due to mechanical interference with other components in the system, so a variety of distances can be used. Distances can be measured from the sample surface or from the sample holder and where the sample is thin, these distances may be substantially the same.

In some embodiments, the inlets described herein may configured to provide the agent such that a partial pressure of the agent is less than 1×10⁻⁶ mbar or less than 1×10⁻⁷ mbar or less than 1×10⁻⁸ mbar or less than 1×10⁻⁹ mbar or less than 1×10⁻¹⁰ mbar in the vacuum chamber. This can ensure that the vacuum in the vacuum chamber does not become unusable for analysis (e.g., XPS analysis), while still providing enough agent to change the oxidation state of the surface. Other partial pressures can be used depending on the precise construction of the vacuum chamber and the vacuum pumps used. The inlet may be configured to provide the agent in an amount such that a pressure in the vacuum chamber increases by no more than 10⁻⁵ mbar or by no more than 10⁻⁶ mbar or by no more than 10⁻⁷ mbar or by no more than 10⁻⁸ mbar after introducing the agent. This can also ensure that the introduction of the agent does not cause the vacuum in the vacuum chamber to become unrecoverable within a practical timescale. While a UHV can be recovered with extended periods of pumping (e.g. >30 minutes, or several hours or days), such timescales would prevent immediate (or close to <30 minutes) analysis after oxidation/reduction from the agent and energy source, so it is advantageous to ensure that the pressure in the vacuum chamber does not rise significantly. In some cases, if the agent were leaked at, for example, 104 mbar, but the introduced agent were dry and contaminant-free, then the vacuum would be recoverable but may take some time to recover (such that XPS analysis is less practical).

The vacuum chambers described herein may be a High Vacuum, HV, or an Ultra-high Vacuum, UHV, chamber. Preferred pressures inside the vacuum chamber, that is when the agent is not being leaked into the chamber, may be below 10⁻⁶ mbar, below 10⁻⁷ mbar, below 10⁻⁸ mbar, or below 10⁻⁹ mbar.

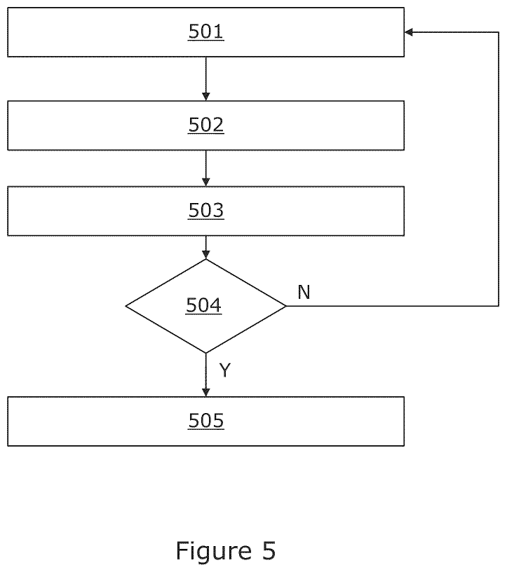

Turning next to FIG. 5, a method of a third embodiment is shown. The method is a process for changing an oxidation state of a surface to be analysed of a sample and performing XPS analysis. The method of FIG. 5 may be described as an iterative workflow that provides iterative changes in oxidation state. The process comprises a first step 501 of providing a sample having a surface to be analysed inside a vacuum chamber. The process further comprises a second step 502 of providing, inside the vacuum chamber and to the surface to be analysed, a localised supply of an agent for changing an oxidation state of the surface to be analysed. The method comprises a third step 503 of providing energy to the agent to facilitate changing the oxidation state of the surface to be analysed, which can occur simultaneously with step 502. The method up until this point corresponds with the basic mode of operation of the apparatus 100 and 200 shown in FIGS. 1 and 2.

At step 504, a determination can be made as to whether a desired degree of change in oxidation state has been attained. If a desired degree of change in oxidation state has not been attained, then further changing of the oxidation state is performed by repeating steps 502 and 503 one or more times to change the oxidation state of the sample further. Steps 502 and 503 could additionally or alternatively be performed for different desired durations of time (which can be configurable by a user of the system). If the desired degree of change in oxidation state has been attained, then the method continues on to step 505, which is a step of obtaining an XPS spectrum. The obtained XPS spectrum will further indicate the degree of change in oxidation state has been attained by steps 502 and 503. The degree of change in oxidation state could be measured continuously, for example by continuously obtaining XPS spectra, the apparatus could be configured to change the oxidation state a certain number of times, or the apparatus could be configured to provide a predetermined amount of agent to attain a desired degree of change in oxidation state.

The method in FIG. 5 could be modified in many ways. For example, instead of repeatedly changing the oxidation state and acquiring only a single XPS spectrum when a desired degree of change in oxidation state has been attained, the method of FIG. 5 could obtain an XPS spectrum as part of step 504. In this way, an XPS spectrum can be obtained for each different oxidation state. Therefore, a plurality of XPS spectra, each associated with a different oxidation state, can be obtained.

Methods of analysis of XPS spectra obtained using embodiments of the present disclosure are described in more detail in WO-2023/031626A1, which is incorporated herein by reference. For example, the “peak fitting” (i.e., how the XPS spectra of the different oxidation states are used) described in WO-2023/031626A1 can be used in embodiments of the present disclosure. In some embodiments, the methods described herein may comprise analysing a plurality of XPS spectra by comparing the XPS spectra recorded at each oxidation state, as described in p. 12 of WO-2023/031626A1. In some embodiments, the methods described herein may comprise extracting component peaks in the plurality of spectra that vary together (see p. 13 of WO-2023/031626A1, for instance) numerically in a computer using a multivariate statistical method. As explained in p. 12 of WO-2023/031626A1 in some embodiments of the present disclosure, Principal Component Analysis (PCA), non-negative matrix factorization (NMF) or Singular Value Decomposition (SVD) can be used, or machine learning algorithm can be used as described in p. 33 thereof. Moreover, some embodiments may involve identifying chemical states within the sample based on extracted component peaks (using the extracted component peaks to perform peak fitting of XPS spectra).

Hence, in generalised terms, the methods described herein may further comprise analysing the plurality of XPS spectra by comparing the XPS spectra of the plurality of different oxidation states. Comparing the XPS spectra may comprise extracting component peaks in the plurality of XPS spectra that vary together, for example using a multivariate statistical method on a computer, such as PCA, NMF or SVD methods or the like. The methods may further comprise identifying one or more chemical states within the sample based on one or more peaks in the plurality of XPS spectra, for example one or more of the extracted peaks. The methods may further comprise identifying one or more peaks from the plurality of XPS spectra by performing a multivariate statistical analysis, preferably by performing any one or more of: principal component analysis; non-negative matrix factorization; singular value decomposition; and/or a machine learning algorithm.

From the foregoing, it will be apparent that the apparatus and methods described herein provide a number of advantages.

Embodiments described herein can generate an agent for changing the oxidation state of a sample surface in-situ, for example inside a vacuum chamber of an analytical instrument. Doing so can reduce the number of times a sample is transferred into and out of an instrument. This can be used in, for example, automated workflows that iterate between ozonation and XPS analysis. The ability to change the oxidation state of samples in-situ can provide precise control over the oxidation state of samples and can avoid exposing the samples to moisture or contaminants. Therefore, embodiments of the present disclosure can reliably and accurately oxidise sample surfaces.

Localised leaking of air (or another agent for changing the oxidation state of a surface) to provide the oxygen for ozone generation can prevent the UHV from being unrecoverable through contamination or significant leakage. As a result, this can vastly speed up the iterative workflows described in WO-2023/031626A1.

Ozone is a particularly advantageous oxidising agent that can be used for oxidising sample surfaces that are relatively unreactive to atmospheric oxygen.

The UV sources that are typically installed on many XPS instruments for the purposes of ultraviolet photoelectron spectroscopy (UPS) can be used to generate UV light that is suitable for generating ozone from oxygen. A preferred wavelength of the UV radiation for achieving this is 100 nm-240 nm, particularly if oxygen (or air) is leaked locally to the sample surface.

Many variants of the embodiments described above can be provided.

In FIGS. 1 and 2, the inlets 104 and 204 and the energy sources 105 and 205 are provided as separate components. In some embodiments, they could be provided on a single common structure, to minimise the space taken up in the vacuum chambers. As an example, a needle with an inlet at the end could be attached to or formed integrally with the side of the UV light source 205 and could extend towards the sample 203 in the same direction as the direction in which the UV light travels.

Moreover, the embodiments described above are described principally in relation to XPS. However, other analytical techniques can benefit from improved control over the oxidation state of the sample. Therefore, embodiments of the present disclosure can be used in other photoemission analysis techniques, or in other vacuum-based analytical instruments (e.g. electron microscopy).

As mentioned in connection with FIG. 1, the energy source could provide electrical energy. Accordingly, instead of a UV light, an electrode can be provided, to provide an electrical discharge to activate an agent. For example, electrical discharge can provide sufficient energy to break oxygen bonds to generate free atoms of oxygen, which can subsequently provide ozone for ozonation of a sample surface. Accordingly, some embodiments provide an electrode extending into the vacuum chambers described herein. A power supply may be connected, or the electrode may be configured to be connected to a separate power supply, with the power supply being capable of applying a high enough voltage (e.g. at least 2 V or at least 1 kV or at least 4 kV) to break oxygen bonds.

The embodiments of FIGS. 1 and 2 can be used to automate analysis and/or to provide iterative changes in oxidation state and analysis. Accordingly, a controller may be provided and may be configured to control the operations of the energy source, the inlet for supplying agent, and any analytical instruments (e.g., detectors) used for analysis. In some embodiments, the sample holders may comprise moveable sample stages to allow the position of the sample with respect to the inlet and/or the energy source to be fine-tuned. In such a case, the controller may be configured to control the position of the sample holder as well. The present disclosure also provides a computer program comprising instructions for causing any of the hardware described herein to perform any of the functionality described herein may be provided, and a computer-readable medium comprising such a computer program may also be provided.

It will be understood that many variations may be made to the above systems and methods whilst retaining the advantages noted previously.

For example, in some embodiments, ozone may be generated outside a vacuum chamber and provided directly to the surface of the sample to be analysed. Accordingly, in some embodiments, ozone may be fed directly to the sample surface and in such a case, the energy source may be omitted from the apparatus described herein. For example, in some aspects of the present disclosure, there may be provided an apparatus for changing an oxidation state of a surface to be analysed of a sample, the apparatus comprising: a vacuum chamber; a sample holder inside the vacuum chamber, configured to hold a sample having a surface to be analysed; and an inlet inside the vacuum chamber, configured to provide a localised supply, to the surface to be analysed, of an agent for changing an oxidation state of the surface to be analysed. In such an embodiment, the agent may be ozone.

Each feature disclosed in this specification, unless stated otherwise, may be replaced by alternative features serving the same, equivalent or similar purpose. Thus, unless stated otherwise, each feature disclosed is one example only of a generic series of equivalent or similar features.

As used herein, including in the claims, unless the context indicates otherwise, singular forms of the terms herein are to be construed as including the plural form and, where the context allows, vice versa. For instance, unless the context indicates otherwise, a singular reference herein including in the claims, such as “a” or “an” (such as an agent or an energy source) means “one or more” (for instance, one or more agents, or one or more energy sources). Throughout the description and claims of this disclosure, the words “comprise”, “including”, “having” and “contain” and variations of the words, for example “comprising” and “comprises” or similar, mean that the described feature includes the features that follow, and are not intended to (and do not) exclude the presence of other components.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure. Any steps described in this specification may be performed in any order or simultaneously unless stated or the context requires otherwise. Moreover, where a step is described as being performed after a step, this does not preclude intervening steps being performed.

All of the aspects and/or features disclosed in this specification may be combined in any combination, except combinations where at least some of such features and/or steps are mutually exclusive. In particular, the preferred features of the disclosure are applicable to all aspects and embodiments of the disclosure and may be used in any combination. Likewise, features described in non-essential combinations may be used separately (not in combination).

We claim:

1. An apparatus for changing an oxidation state of a surface to be analysed of a sample, the apparatus comprising:
a vacuum chamber;
a sample holder inside the vacuum chamber, configured to hold a sample having a surface to be analysed;
an inlet inside the vacuum chamber, configured to provide a localised supply, to the surface to be analysed, of an agent for changing an oxidation state of the surface to be analysed; and
an energy source, configured to provide energy to the agent to facilitate changing the oxidation state of the surface to be analysed.

2. The apparatus of claim 1, wherein the energy source comprises a radiation source.

3. The apparatus of claim 2, wherein the radiation source is an electromagnetic radiation source.

4. The apparatus of claim 3, wherein a wavelength of the electromagnetic radiation source is from 100 nm to 240 nm.

5. The apparatus of claim 3, wherein a wavelength of the electromagnetic radiation source is tuneable.

6. The apparatus of claim 3, wherein the radiation is ultraviolet, UV, or extreme ultraviolet, EUV, radiation.

7. The apparatus of claim 3, wherein the electromagnetic radiation source comprises any one or more of: a mercury vapour lamp; an ultraviolet bulb; a light emitting diode; a gas discharge lamp; plasma-based ultraviolet source; and/or a microwave plasma ultraviolet source.

8. The apparatus of claim 1, wherein the energy source comprises an electrode configured to provide an electrical discharge to the agent.

9. The apparatus of claim 1, wherein the energy source is inside the vacuum chamber.

10. The apparatus of claim 1, wherein the energy source is configured to activate the agent.

11. The apparatus of claim 1, wherein the agent is gaseous.

12. The apparatus of claim 1, wherein the agent comprises any one or more of: oxygen; ozone; and/or hydrogen.

13. The apparatus of claim 1, wherein the inlet comprises a leak valve.

14. The apparatus of claim 1, wherein the inlet comprises an elongate conduit extending towards the surface to be analysed.

15. The apparatus of claim 14, wherein the inlet terminates in close proximity to the surface to be analysed, preferably at a distance of:
up to 200 mm or up to up to 100 mm from the surface to be analysed; and/or
at least 5 mm, at least 10 mm, or at least 50 mm from the surface to be analysed.

16. The apparatus of claim 1, wherein:
the inlet is configured to provide the agent such that a partial pressure of the agent is less than 1×10⁻⁶ mbar or less than 1×10⁻¹⁰ mbar in the vacuum chamber; and/or
the inlet is configured to provide the agent in an amount such that a pressure in the vacuum chamber increases by no more than 10⁻⁵ mbar after introducing the agent.

17. The apparatus of claim 1, wherein the vacuum chamber is a High Vacuum, HV, or an Ultra-high Vacuum, UHV, chamber, preferably wherein a pressure inside the vacuum chamber is below 10⁻⁶ mbar, below 10⁻⁷ mbar, below 10⁻⁸ mbar, or below 10⁻⁹ mbar.

18. The apparatus of claim 1, wherein the vacuum chamber is an X-ray photoelectron spectroscopy, XPS, analysis chamber, preferably comprising an X-ray source and a photoelectron energy analyser.

19. The apparatus of claim 1, configured to change the oxidation state of the surface to be analysed a plurality of times while the sample is inside the vacuum chamber.

20. The apparatus of claim 19, configured to obtain an X-ray photoelectron spectroscopy, XPS, spectrum for each of a plurality of oxidation states of the surface to be analysed.

21. A process for changing an oxidation state of a surface to be analysed of a sample, the process comprising:
providing a sample having a surface to be analysed inside a vacuum chamber;
providing, inside the vacuum chamber and to the surface to be analysed, a localised supply of an agent for changing an oxidation state of the surface to be analysed; and
providing energy to the agent to facilitate changing the oxidation state of the surface to be analysed.

22. A process for performing X-ray photoelectron spectroscopy, XPS, of a surface to be analysed of a sample, comprising:
repeating the process of claim 21 one or more times, thereby providing a plurality of different oxidation states of the surface to be analysed inside the vacuum chamber, wherein the vacuum chamber is an XPS analysis chamber; and
obtaining a plurality of XPS spectra, the plurality of XPS spectra comprising an XPS spectrum for each of the plurality of different oxidation states of the surface to be analysed.

23. The process of claim 22, further comprising analysing the plurality of XPS spectra by comparing the XPS spectra of the plurality of different oxidation states.

24. The process of claim 22, further comprising identifying one or more chemical states within the sample based on one or more peaks in the plurality of XPS spectra.

25. The process of any of claim 22, further comprising identifying one or more peaks from the plurality of XPS spectra by performing a multivariate statistical analysis, preferably by performing any one or more of: principal component analysis; non-negative matrix factorization; singular value decomposition; and/or a machine learning algorithm.
